(19) United States
(12) Patent Application Publication
(10) Pub. No.: US 2025/0252710 A1
(43) Pub. Date: Aug. 7, 2025

(54) MULTI-DOMAIN CLASSIFICATION USING DIFFUSION MODELS

(71) Applicant: Google LLC, Mountain View, CA (US)

(72) Inventors: Lavisha Aggarwal, Bellevue, WA (US); Mar Gonzalez Franco, Seattle, WA (US); Andrea Colaco, Los Altos, CA (US)

(21) Appl. No.: 19/042,858

(22) Filed: Jan. 31, 2025

Related U.S. Application Data
(60) Provisional application No. 63/548,577, filed on Feb. 1, 2024.

(51) Int. Cl. G06V 10/764; G06V 10/82

(52) U.S. Cl. CPC G06V 10/764; G06V 10/82

(57) ABSTRACT

A method including generating a relationship between a portion of an image and terms in a prompt that represents a correlation strength between the portion and a word in the prompt, calculating a score based on the data, the score indicating a measure of the number of pixels correlated to the word, and determining whether the portions of the image are associated with a group based on the score, where the word is associated with an item in the group.

### CROSS-REFERENCE TO RELATED APPLICATION

This application claims priority to U.S. Provisional Patent Application No. 63/548,577, filed on Feb. 1, 2024, entitled “MULTI-DOMAIN CLASSIFICATION USING STABLE DIFFUSION MODELS”, the disclosure of which is incorporated by reference herein in its entirety.

### BACKGROUND

Image classification is a fundamental process for various computer tasks, including computer vision. Classification can entail identifying the most significant entity in, largely single-entity, images. Classification can entail determining whether a particular image includes a specific entity.

### SUMMARY

Implementations include using a model (e.g., a diffusion model, a stable diffusion model, a text-to-image model, a U-NET model, and/or the like) that does not involve task-specific training for a multi-domain classification process. The model can use encoded text and an encoded image as input and classify items included in the image that match a prompt. These items can correspond to nouns, such as objects, backgrounds, activities, emotions to name a few. Put another way, the prompt defines an item that represents a class (a group) and disclosed implementations use the prompt and a model trained only to generate images from a prompt to determine a probability that an image includes the item, i.e., a classification of that item into the class, or in other words, classification of that item into a group. Thus, in disclosed implementations, the prompt defines (corresponds to) the class against which implementations will test the image.

In a general aspect, a device, a system, a non-transitory computer-readable medium (having stored thereon computer executable program code which can be executed on a computer system), and/or a method can perform a process with a method including generating data representing a relationship between portions of an image and a word in a prompt that represents a correlation strength between the portions and the word, calculating a score based on the data, the score indicating a measure of the number of pixels correlated to the word, and determining whether the portions of the image are associated with a group based on the score, where the word is associated with an item in the group. In another general aspect, a device, a system, a non-transitory computer-readable medium (having stored thereon computer executable program code which can be executed on a computer system), and/or a method can perform a process with a method including receiving first data at a first resolution, the first data generated using a model, the first data reflecting relationships between portions of an image and a word in a prompt that represents a correlation strength between the portions and the word, receiving second data at a second resolution, the second data generated using the model, the second data reflecting relationships between the portions of the image and the word that represents the correlation strength between the portions and the word, aggregating the first data and the second data as aggregated data, normalizing the aggregated data to generate refined aggregated data, calculating a score for the word from the refined aggregated data, and providing a probability indicating whether the portions of the image are associated with a group based on the score, where the word is associated with an item in the group.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a block diagram of a data flow for predicting a classification according to an example implementation.

FIG. 2 illustrates a block diagram of a system supporting a general multi-domain classifier, according to at least one example implementation.

FIG. 3 illustrates a result of a standardization process for an input image and two prompts according to at least one example implementation.

FIG. 4 illustrates aggregation according to at least one example implementation.

FIG. 5 illustrates a block diagram of a method implementing a classification task using a general multi-domain classifier according to at least one example implementation.

FIG. 6 illustrates a block diagram of a method of classification according to at least one example implementation.

FIG. 7 is a block diagram of a method of classification according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Classification is the task of predicting which of a set of classes (categories) an example belongs to. For example, a logistic regression model can be used to predict a probability into a binary classification model that predicts one of two or more classes. Image classification systems can identify objects in images. For example, image classification systems can be used to classify input images as including objects from one or more object categories. Some image classification systems use one or more neural networks to classify an input image. In some implementations, a class can be a group (e.g., group of words) where a word is associated with an item in the group. Neural networks are machine learning models that employ one or more layers of models to predict an output for a received input. Some neural networks include one or more hidden layers in addition to an output layer. The output of each hidden layer is used as input to the next layer in the network. Each layer of the network generates an output from a received input in accordance with current values of a respective set of parameters.

At least one technical problem with classification is that most classifiers require supervised training for each class (domain). Essentially, in order to develop the capability to fully understand an image, the first step is to find the overall theme and the primary entity in the scene. This is most often done in the form of models trained on predefined, often small, sets of object categories among which the model is expected to choose from and assign the most relevant class to every image. Because entities can be of varying types, such as animals, sports, vehicles, pets, fruits, distinct models are trained for each individual domain on a preset fixed collection of classes; and any changes such as addition, removal, replacement of a class, e.g., if a ten animal class detector needs to detect a new class (such as koala, or if the class detector is to be expanded to detect vegetable types too, this requires a fresh setup, including the curation of a dataset with the new set of classes, training a new model and fine tuning its hyperparameters and model weights for that specific setup. A single model can be capable of classifying across multiple domains for a variable set of classes is not well established yet. Current approaches include models with a large number of (˜1000) classes and assume this set of classes will be sufficient, but this assumption is easily breakable.

At least another technical problem with classification is that neural-net models are trained in a supervised fashion where they are fed huge amounts of image-label pairs corresponding to the specific task they are being taught to perform.

Disclosed implementations provide at least one technical solution by providing a model (classifier) that does not involve task-specific training. In other words, disclosed implementations provide a multi-domain classifier that is never explicitly given pairs of image-class name labels or taught to interpret an image to a specific class category. Instead, implementations may make use of the text-to-image paradigm used by a stable diffusion model. Thus, implementations represent a fully unsupervised multi-domain classifier that involves a lightweight post-processing algorithm over the (internal) attention layers of a stable diffusion model backbone to make a classification prediction, i.e., a probability that the image relates to the class. Put another way, disclosed implementations can classify images across multiple domains over a varying number of categories of object classes. In addition to being multi-domain, disclosed implementations provide an unsupervised and zero-shot classifier multi-domain classifier.

Unsupervised and zero-shot segmentation methods are technically challenging because of the combined difficulty of the unsupervised and zero-shot requirements. To address these issues, disclosed implementations utilize the power of a stable diffusion model to construct a multi-domain classification model. Disclosed implementations utilize the discovery that knowledge about entities can be extracted from hidden layers in the stable diffusion (SD) model and used to output a class prediction for an image. In disclosed implementations, the hidden layers are cross-attention layers, also referred to as cross-attention maps. These cross-attention layers (cross-attention maps) depict the correlation between words and image content. The words used to generate the cross-attention maps come from a prompt and represent the class to be tested. Accordingly, disclosed implementations include prompt generation, cross-attention map extraction, and post-processing scoring.

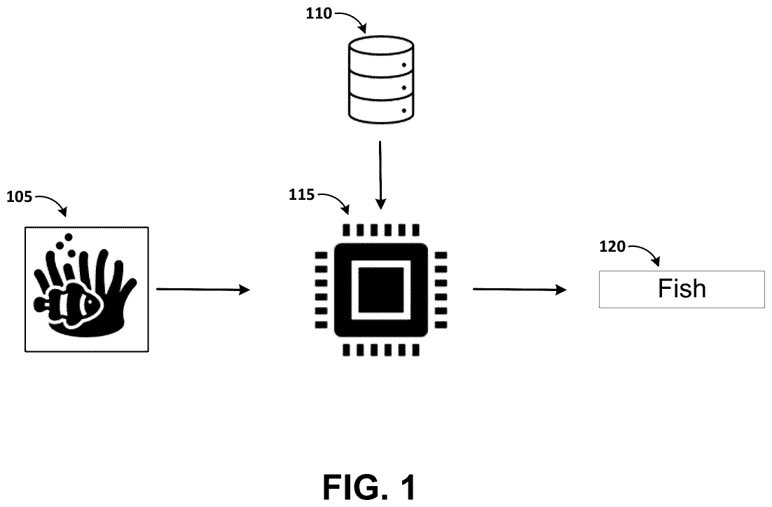

FIG. 1 illustrates a block diagram of a data flow for predicting a classification according to an example implementation. As shown in FIG. 1, the data flow includes an image 105, a model datastore 110, a processor 115, and a predicted classification 120 as an output. Model datastore 110 can include a plurality of models (e.g., neural network models. Some of the models can be trained models and some of the models can be untrained models. A model can be loaded from model datastore 110 into processor 115.

Image 105 can be received by processor 115 and input to the model loaded from model datastore 110. In some implementations, the model loaded from model datastore 110 can be configured to predict a class associated with an object included in image 105. In some implementations, a class can be a group (e.g., group of words) where a word (e.g., associated with an object) is associated with an item in the group. In some implementations, the model loaded from model datastore 110 can be configured to output the class associated with an object included in image 105 as predicted class 120. For example, as shown in FIG. 1, image 105 includes a fish. Therefore, the model loaded from model datastore 110 can predict the class as fish and output the class as fish.

In some implementations, one, two, or more categories can be predicted and output. In some implementations, a class can be referred to as a category and/or class category. In some implementations, a list of categories to identify can be input to the model loaded from model datastore 110 via processor 115.

In some implementations, the model loaded from model datastore 110 can be configured to generate a relationship between a portion of an image and terms (or words) in a prompt that represents a correlation strength between the portion and a term (or word) in the prompt. In some implementations, the relationship between a portion of an image and terms (or words) in a prompt can be referred to as a map or cross-attention map. Therefore, in some implementations, the model loaded from model datastore 110 can be configured to generate a map (cross-attention map) for an input image that represents a correlation strength between a pixel in the input image and a word in a prompt. Further, in some implementations, processor 115 can be configured (using the model) to calculate a score based on the data, the score indicating a measure of the number of pixels correlated to the word (and/or the map). In some implementations, a measure of the number of pixels correlated to the word can be referred to as a coverage. Therefore, processor 115 can be configured (using the model) to calculate a score based on the data (and/or the map), the score indicating a coverage.

In some implementations, coverage can indicate a percentage of total pixels that meet a minimum correlation with the word. In some implementations, coverage can be a measure of the number (quantity) of pixels correlated to the word. In some implementations, coverage can be quantified as a score (or coverage score). In some implementations, a relatively high score (e.g., closer to 1 on a 0 to 1 scale) can indicate relatively high coverage. In other words, coverage can be a measure of the number (quantity) of pixels highly correlated to the word. In some implementations, a relatively low score (e.g., closer to 0 on a 0 to 1 scale) can indicate relatively low coverage. In other words, coverage can be a measure of the number (quantity) of pixels minimally correlated to the word. In some implementations, to identify a class, the coverage should meet a minimum coverage. In other words, a minimum coverage may be needed to indicate a class. Accordingly, a minimum score may be needed to indicate a class. Further, in some implementations, a class can be a group (e.g., group of words) where a word is associated with an item in the group. Therefore, in some implementations, the model loaded from model datastore 110 can be configured to determine a group based on the score, where a word is associated with an item in the group. Alternatively (or in addition to) in some implementations, the model loaded from model datastore 110 can be configured to determine a class based on the score, where the class corresponds to the prompt.

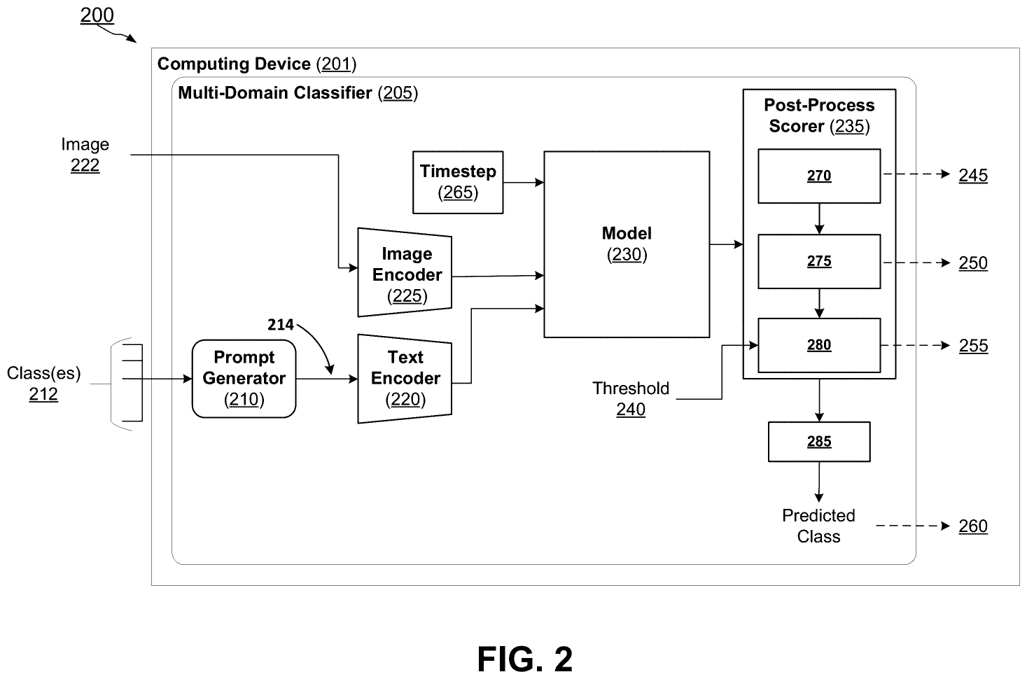

FIG. 2 illustrates a block diagram of a system supporting a general multi-domain classifier, according to at least one example implementation. As shown in FIG. 2, a system 200 can include a general multi-domain classifier 205. In some implementations, the general multi-domain classifier 205 can include a prompt generator 210. The prompt generator can be configured to (or help) convert class names, e.g., classes 212, into natural language captions, i.e., into prompts 214. A prompt 214 is generated for each class 212 provided to the prompt generator 210. Where the given classes 212 represent individual entities, the prompt generator 210 can convert the classes 212 to simple prompts, such as “a photo of a <class>,” where <class> is replaced with one of the provided classes 212.

Because the general multi-domain classifier 205 is zero-shot, any word can be a class, including verbs. This is an improvement over existing classifiers, which are not trained to identify images depicting actions identified by verbs. Classes 212 may be one class, two classes, and/or a plurality of classes. For example, some implementations can work with one word or one phrase. Classes 212 may be one or more complex classes. In some implementations, a class can be a group (e.g., group of words) where a word is associated with an item in the group. A complex class includes multiple classes/domains. An example of a complex class is “images of a man cooking” or “images of dogs playing”. Put another way, classes 212 may include one or more classes that represent a given natural language caption. If the class is a given natural language caption, the prompt generator 210 may not change the class when generating the respective prompt 214 for the class.

In some implementations, a user can provide the natural language caption. For example, some implementations can be used for custom but complex searching of a database of images. While results may not be returned within seconds, a server (e.g., where computing device 201 is a server) could be configured to perform parallel classification tasks on the images in the database and responsive images (e.g., images that are classified as within the natural language query) could be returned within a few minutes. In some implementations, a user can request that images in an image repository be tagged with a new tag based on a given natural language caption used as a class 212 to facilitate faster searching and identification in the future. Such tags could be added to new images as they are added to the repository, e.g., by running the general multi-domain classifier 205 on images as they are added to a repository. Although illustrated as part of the general multi-domain classifier 205, in some implementations the prompt generator 210 can be separate from the general multi-domain classifier 205.

In some implementations, the general multi-domain classifier 205 can include an image encoder 225, such as variational autoencoder (VAE). In some implementations, the general multi-domain classifier 205 can include a text encoder 220. In some implementations, the image encoder 225 and/or the text encoder 220 can be separate from the general multi-domain classifier 205. The image encoder 225 can receive an input image 222 and encode the input image 222 into a format accepted by model 230. In some implementations, the model 230 can be a stable diffusion model. The input image 222 can represent the image on which classification is performed. The text encoder 220 can map the prompt 214 (e.g., a sequence of input tokens) to a sequence of latent text-embeddings. The text embeddings can be a format accepted (e.g., expected by) the model 230.

As mentioned above, model 230 can be a stable diffusion model. A stable diffusion model is a variant of the diffusion model family, which is a type of generative model, used for computer vision applications. A diffusion model can be configured to learn a forward and reverse diffusion process to generate an image from a sampled isotropic Gaussian noise image. More specifically, diffusion models have a forward and reverse pass. In the forward pass, at every time step, a small amount of Gaussian noise is iteratively added until an image becomes an isotropic Gaussian noise image. In the reverse pass, the diffusion model is trained to iteratively remove the Gaussian noise to recover the original clean image. Earlier diffusion models conduct the diffusion process in the original high-dimensional image space, which is slow to train and causes instability.

The stable diffusion model can introduce an encoder-decoder and U-Net design with attention layers to address the instability issue, and can optionally add conditions for image generation, such as text prompt. A stable diffusion model can include an encoder-decoder module and a latent space diffusion U-Net. An image is first compressed by the encoder to a smaller latent space and is fed to the diffusion U-Net to go through the diffusion process and is finally decompressed to the original image space by the decoder. The U-Net is a stack of modular blocks consisting of ResNet modules and Transformer modules. A stable diffusion model can first compress an image x∈ [symbol] into a hidden space with smaller spatial dimension z∈ [symbol] using an encoder z=ε(x), which can be decompressed through a decoder \tilde{x}= [symbol] (z). In some implementations, all diffusion processes can happen in the compressed latent space through a U-Net architecture.

The U-Net architecture can include a stack of modular blocks. 16 of the modular blocks can have two major components: a ResNet layer and a Transformer layer. The Transformer layer can use two types of attention mechanisms, self-attention, and cross-attention, to learn the global attention across the image and the cross-attention between the image and the caption (e.g., between input image 222 and prompt 214). The component of interest for disclosed implementations is the cross-attention layer in the Transformer layer.

As model 230 maximizes the probability of a generated image x given a caption c, i.e., p(x|c), the cross-attention layers of the model 230 can be configured to store activation maps representing the correlation between each word in the caption (the prompt 214) and the generated image at the time step. Implementations can exploit the cross-attention layers for performing classification. Specifically, the general multi-domain classifier 205 can be configured to combine the encoded image (from image encoder 225) and the encoded prompt (from text encoder 220) and passes them through the stable diffusion model 230 at a pre-specified timestep 265 (T*). As indicated above, the stable diffusion model 230 can include a U-Net backbone. This U-Net backbone can include cross-attention layers at multiple image resolutions (64×64, 32×32, 16×16, 8×8). In some implementations, a map can be referred to as data. In some implementations, a map can be referred to as data points. In some implementations, two or more maps can be referred to as a plurality of data. In some implementations, two or more maps can be referred to as a plurality of data points. Accordingly, an activation map can be referred to as data and/or data points and two or more activation maps can be referred to as a plurality of data and/or a plurality of data points. Further, a cross-attention map can be referred to as data and/or data points and two or more cross-attention maps can be referred to as a plurality of data and/or a plurality of data points.

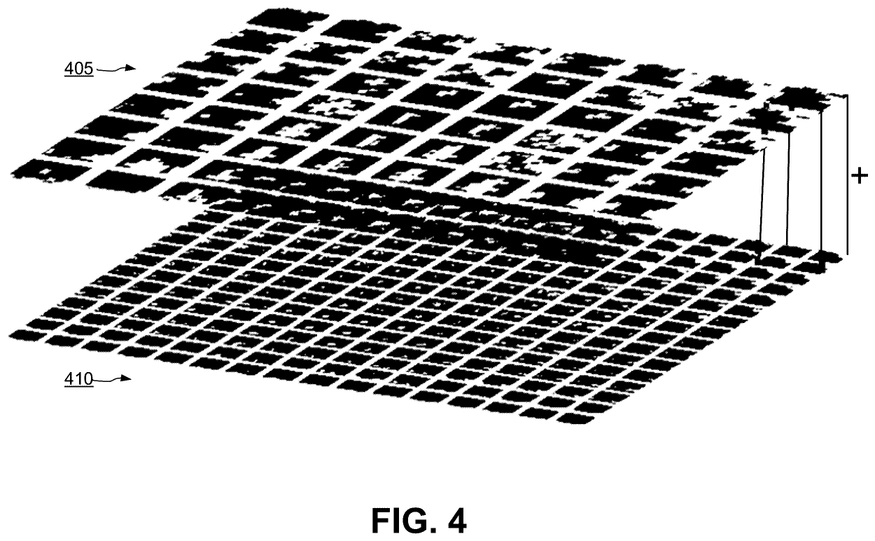

Cross-attention maps can be extracted and sent through the post-process scorer 235 to be aggregated (e.g., as aggregated cross-attention maps 245) and refined (as refined cross-attention maps 250). In cross-attention aggregation 270, activation maps at different resolutions: 64×64, 32×32, 16×16, 8×8 are upsampled to the highest resolution i.e. 64×64 and the post-process scorer 235 takes a weighted average over the different resolutions. Aggregation is discussed in more detail below with respect to FIG. 4.

This yields n 64×64 maps 245 where n corresponds to the number of words in the prompt 214. Put another way, cross-attention aggregation 270 produces n aggregated cross-attention maps 245 for each prompt 214 where n is the number of words in the prompt 214. In some implementations, the post-process scorer 235 ignores predetermined words from the prompt 214. The predetermined words can include stop words, such as a, the, and, of, etc. Ignoring predetermined words can include not generating an aggregated cross-attention map for a word in the predetermined words. Ignoring predetermined words can include not scoring refined cross-attention maps 250 that correspond to the predefined words.

The post-process scorer 235 can refine the aggregated cross-attention maps 245 to generate refined cross-attention maps 250. Although the aggregated cross-attention maps 245 depict the correlation between words and image content, their raw value is noisy and highly susceptible to the specific words and their order in prompt 214. Hence, some implementations can apply a standardization process, referred to as cross-attention refinement.

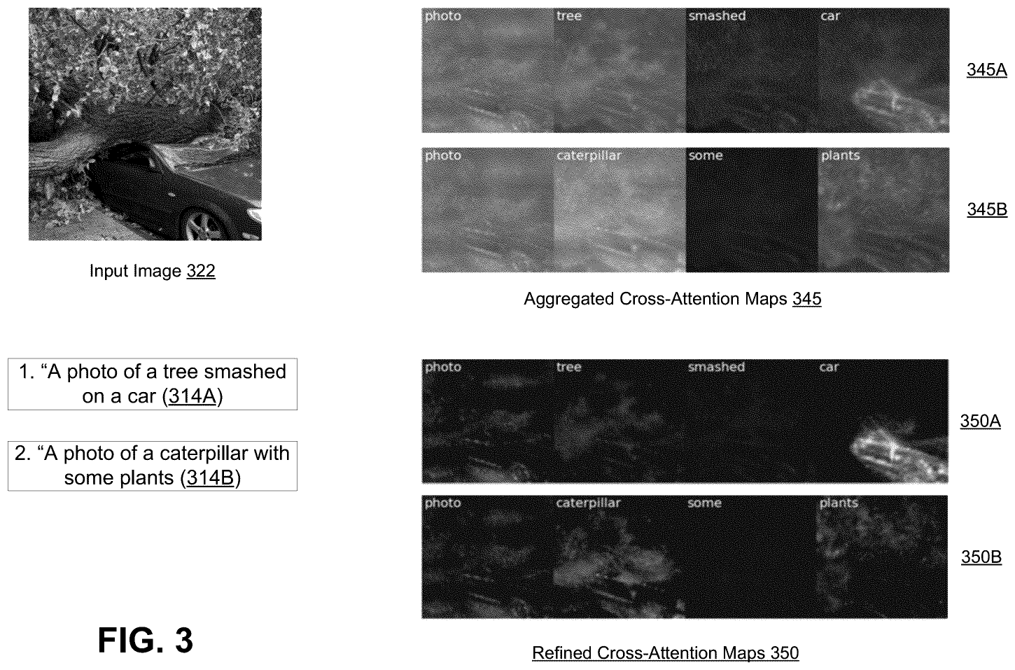

FIG. 3 illustrates the result of the standardization process for an input image 322 and two prompts 314A and 314B. As illustrated in FIG. 3, the aggregation process results in an aggregated cross-attention map for each word in each prompt, represented by aggregated cross-attention maps 345. In FIG. 3, aggregated cross-attention maps 345A correspond to prompt 314A and aggregated cross-attention maps 345B correspond to prompt 345B. Brighter colors (brightness) in the aggregated cross-attention maps 345 represent higher activation, where higher activation represents higher value (e.g., higher probability). Put another way, brightness (e.g., brightness value) of the pixels represents a correlation strength between the word and the pixels, with pixels having brighter values representing higher correlation.

In some implementations, a measure of variation can be used to indicate an activation. For example, the measure of variation can be a standard deviation. FIG. 3 illustrates that in the aggregated cross-attention maps 345, the activation for the word “caterpillar” appears to be the brightest, hence having a highest value (e.g., correlation). However, the entire cross-attention map is bright, with low standard deviation (i.e., low variation). In contrast, in the cross-attention map corresponding to “car” only few specific pixels are light (bright) giving the cross-attention map for “car” a high standard-deviation value (i.e., high variation). Because a cross-attention map with a low standard deviation can represent noise, implementations use a standardization process on the aggregated cross-attention maps 345 to generate refined cross-attention maps 350. In FIG. 3, refined cross-attention maps 350A correspond to words from the prompt 314A, and refined cross-attention maps 350B correspond to words in prompt 314B. In the refined cross-attention maps 350, the activation corresponding to “car” lights up the brightest (showing high correlation), also highlighting the correct pixels, while the refined cross-attention map for “caterpillar” is (correctly) relatively dark (low correlation).

The post-process scorer 235 illustrated in FIG. 2 carries out the standardization process to generate refined cross-attention maps. In cross-attention refinement 275, each aggregated cross-attention map has the mean pixel value for the map, which is calculated and subtracted out. This darkens aggregated maps with low deviation. Each map is then multiplied by its standard deviation to amplify the deviations. For correct word-image pairs, the aggregated cross-attention map lights up a small number of specific pixels, i.e., only those corresponding to the object location in the image. Such images have high deviation, which is amplified by subtracting the mean pixel value and multiplying by the standard deviation. On the other hand, for incorrect word-image pairs, the aggregated cross-attention map can have an overall high or low value depending on other factors. By subtracting the mean pixel value, maps that represent fairly uniform high values end up with low values. Because the standard deviation is low, multiplication results in small change to the low values and the refined cross-attention maps reflect this (e.g., see FIG. 3). Thus, the refined cross-attention maps 250 yield bright pixels at locations with likely correspondence to words in the prompt. As mentioned above, in some implementations refined maps can be generated for each word not in the predefined words.

To determine which class or classes apply to the input image 322, the general multi-domain classifier 205 calculates (using a coverage score estimation 280 process) a coverage score 255 based on the refined cross-attention maps. The coverage score 255 estimates the prompt-image similarity and plays the role of class score for classification. In some implementations, a class can be a group (e.g., group of words) where a word is associated with an item in the group. The primary assumption behind this metric is that the correct caption or class will yield the highest number of pixels, cumulated over all words in the caption, covering the largest region of the image. To compute this metric, a brightness threshold t is used (e.g., threshold 240). Pixels with values greater than the brightness threshold t are identified and the union of these pixels is calculated. This union can occur for a single word map (one word from the prompt), giving a coverage score 255 for the word. This union can occur across all words in the prompt, giving a coverage score 255 for the prompt. The ratio of this count to total number of image pixels is returned as the coverage score 255 of the classification represented by the prompt 214 (where the union is over all words in the prompt) by the word (where the union is for a single word from prompt 214).

As mentioned above, coverage can indicate a measure of the number of pixels correlated to the word. As mentioned above, coverage can indicate a measure of the quantity of pixels correlated to the word. As mentioned above, coverage can indicate a percentage of pixels that meet a minimum correlation with the word. As mentioned above, coverage can indicate a percentage of total pixels that meet a minimum correlation with the word.

Where multiple classes 212 are provided for the input image, the process of encoding the prompt 214, generating cross-attention maps by model 230, aggregating the cross-attention maps 245, refining the cross-attention maps 250, and calculating a coverage score 255 based on the refined cross-attention maps is repeated for each class. Finally, the class corresponding to the highest coverage score 285 (e.g., Arg. Max. over all classes) is considered the predicted class (the predicted classification) and provided as output 260.

In some implementations, any class with a coverage score 255 that meets a coverage threshold is provided as output 260. In other words, two or more objects can be included in image 222 that are associated with classes 212. Therefore, output 260 can include two or more classes with a coverage score that meets a coverage threshold. Similarly, coverage score 255 and/or the highest coverage score 285 can include two or more scores corresponding to the two or more classes. The highest coverage score 285 can include two or more scores if, for example, the two or more scores are with a threshold value. In some implementations, the coverage score 255 for each class (e.g., each class of classes 212 or each word of prompt 214) is provided as output 260.

Attention Aggregation. In a single denoising pass through the U-Net, a stable diffusion model generates 16 attention tensors. Specifically, 5 of them have dimension 64×64×64×64, 5 have 32×32×32×32, 5 have 16×16×16×16 and 1 has 8×8×8×8. The post-process scorer 235 can be configured to aggregate attention tensors of different resolutions into the highest resolution tensor. To achieve this, the post-process scorer 235 treats the 4 dimensions differently. The 2D map Aₖ[I, J, :, :] corresponds to the correlation between all spatial locations to the location (I, J). Therefore, the last 2 dimensions in the attention maps are spatially consistent despite different resolutions. Therefore, the post-process scorer 235 upsamples (bi-linear interpolation) the last 2 dimensions of all attention maps to 64×64, the highest resolution of them. Formally, for Aₖ∈ [symbol] :

$${k}_{} = Bilinear - upsample ( {A}_{k} ) ∈ .$$

On the other hand, the first 2 dimensions indicate the locations to which attention maps are centered around. Therefore, the post-process scorer 235 can be configured to aggregate attention maps accordingly. Put another way, an attention map from a lower resolution is first upsampled and then added to several corresponding high-resolution maps. For example, as shown in FIG. 4, the attention map 405 a portion in the (0, 7) location in Aₖ∈ [symbol] is first upsampled and then repeatedly aggregated pixel-wise with the 4 attention maps (0, 14), (0, 15), (1, 15), (1, 14) in A_{z}∈ [symbol] (a corresponding portion of attention map 410 of FIG. 4). Put another way, a portion (in the (0, 7) location) of attention map 405 corresponds to a portion (in the (0, 14), (0, 15), (1, 15), (1, 14) locations) of the attention map 410, and the portion of attention map 405 is upsampled before being added to the portion of attention map 410. (Formally, the final aggregated attention map A_{f}∈ [symbol] is,

$$\begin{matrix}{f}_{} [ I , J , ∶ , ∶ ] = {\sum }_{k ∈ \{ 1 , … , 16 \}} {k}_{} [ I / {δ}_{k} , J / {δ}_{k} , ∶ , ∶ ] * {R}_{k} , \\ where {δ}_{k} = 64 / {w}_{k} , {\sum }_{k} {R}_{k} = 1.\end{matrix} \qquad ( 3 )$$

where / denotes floor division here. Furthermore, to ensure that the aggregated attention map is a valid distribution, i.e., ΣA_{f}[I, J, :, :]=1, the post-process scorer 235 can be configured to assign every attention map of different resolution a weight proportional to its resolution Rₖ∝wₖ.

The weights R can be hyper-parameters configured to control a tradeoff between detail and large objects. Giving more weight to high-resolution attention maps leads to more detailed but potentially more fractured classification, whereas highlighting low-resolution attention maps gives more coherent classification for large objects. Some implementations can tune them for specific datasets. Some implementations may not tune the weights for specific data sets.

Aggregation weights (R). The first step of disclosed implementations is attention aggregation, where attention maps of 4 resolutions are aggregated together. Implementations can adopt a proportional aggregation scheme. Specifically, the aggregation weight for a map of a certain resolution is proportional to its resolution, i.e., high resolution maps are assigned higher importance. This is motivated by the observation that high resolution maps have a smaller receptive field with respect to the original image thus giving more details.

Timestep (t) (e.g., timestep 265). The stable diffusion model can use a time step t to indicate the current stage of the diffusion process. Because implementations run a single pass through the diffusion process, the timestep becomes a parameter that can be set by the system 200 or provided to the system 200.

Brightness threshold (t) (or threshold 240). The coverage score estimation 280 process uses a brightness threshold t. This threshold can be a parameter provided to the general multi-domain classifier 205. The parameter can be tuned separately for each dataset. Too small a threshold leads to too many predicted classes and too large leads to too few predicted classes.

Because the general multi-domain classifier 205 works on many different types of domains and datasets without training and without annotation, it is easily extensible to varying number of classes, class edits, and complex classes. While implementations perform well on diverse datasets, because no training is needed, supervised methods can outperform on specific tasks.

Some implementations can be implemented in a mobile device. For example, a mobile device can include a mobile phone, a tablet, a laptop, and the like. Some implementations can be implemented in a wearable device. For example, the wearable device can be a head worn device, a wearable display, a virtual reality (VR) device, an augmented reality (AR) device, a mixed reality (MR) device, smart glasses, and the like. The mobile device and/or the wearable device should include a camera (e.g., a forward-looking camera, a world-facing camera, and the like).

In some implementations, the camera can capture an image (e.g., image 105, 222, 322) and the user of the mobile device and/or the wearable device can input classification(s). For example, the user can save a class(es) in a memory of mobile device and/or the wearable device as, for example, a list of class(es). For example, the user can speak class(es), and a speech-to-text tool can convert the speech to text which can then be saved as class(es). For example, the user can retrieve class(es) from the web using, for example, a web browser. Other techniques for acquiring class(es) can be used and are withing the scope of this disclosure.

A use case can be, for example, a scavenger hunt. A user can participate in a scavenger hunt. The user can use a wearable device, for example smart glasses, including a forward-looking camera or a world-facing camera. The user can speak a list (e.g., a group) of items (e.g., a group of words) associated with the scavenger hunt. The wearable device can use a speech-to-text tool which can convert the speech to text and then be saved on the wearable device as classification(s). Then as the user walks around wearing the wearable device, the camera of the wearable device can regularly (e.g., in 10 second intervals) capture an image. A classification can be determined based on the image and the stored class(es) as described above. The class(es) can be used to help the user identify and locate the items associated with the scavenger hunt.

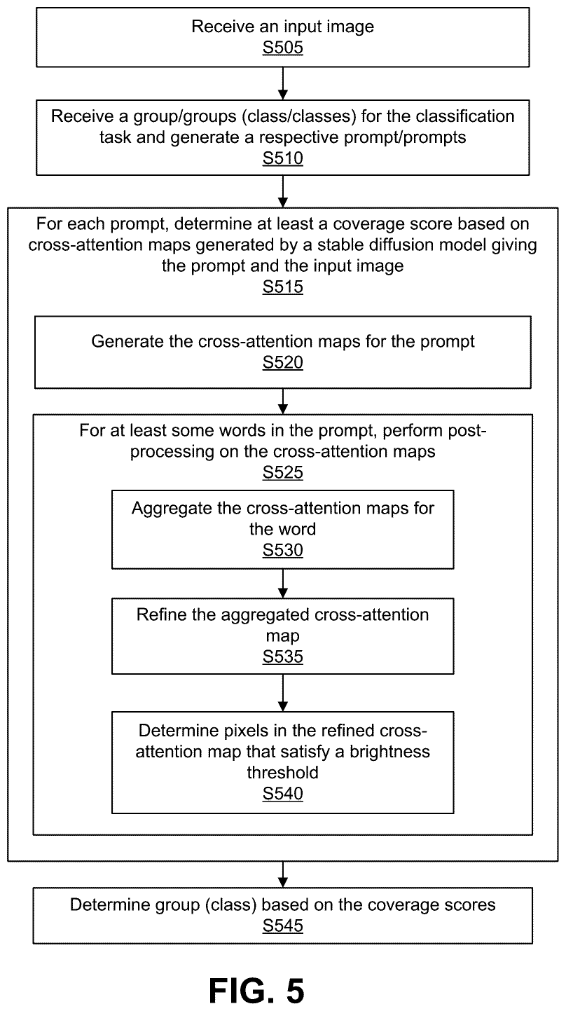

FIG. 5 illustrates a method implementing a classification task using a general multi-domain classifier, according to aspects of the disclosure. This method can be implemented by a computing device, such as computing device 201 of FIG. 2. The method can include receiving an input image (step S505). The input image can be encoded. The input image can be encoded by a variational autoencoder. The method can include receiving a class for the classification task (step S510). In some implementations, that class can represent an item. In some implementations, the class can represent an action. In some implementations, the class can be a complex class representing more than one entity, more than one action, or at least an action and an entity. In some implementations, a class can be a group (e.g., group of words) where a word is associated with an item in the group. In some implementations more than one class can be received. In some implementations, a prompt can be generated for the class. The prompt can be generated using the word/words provided for the class. Because the cross-attention maps can be sensitive to small changes in the words provided to the stable diffusion model, the prompt generator can be configured to generate a prompt from the class that improves the accuracy of the multi-domain classifier.

For each prompt the method can determine a coverage score for the prompt based on cross-attention maps generated by a stable diffusion model given the prompt and the input image (step S515). The stable diffusion model can receive the encoded image and the text encoding for the prompt and can produce cross-attention layers, as described herein (step S520). As part of determining the coverage score, the method can include post-processing for at least some words in the prompt (step S525).

As mentioned above, coverage can indicate a measure of the number of pixels correlated to the word. As mentioned above, coverage can indicate a measure of the quantity of pixels correlated to the word. As mentioned above, coverage can indicate a percentage of pixels that meet a minimum correlation with the word. As mentioned above, coverage can indicate a percentage of total pixels that meet a minimum correlation with the word.

In some implementations, the post-processing can exclude predetermined words from the prompt (e.g., stop words and preposition words, etc.). The post-processing includes aggregating the cross-attention maps for the word from different resolutions (step S530). The method includes refining the aggregated cross-attention map (step S535). Refining can include subtracting the pixel mean of the map from each pixel value. Refining can include multiplying the map by the standard deviation of the map. Refining generates a refined cross-attention map for the word from the aggregated cross-attention map. The refined cross-attention map is a map for the input image that represents correlation strength between the pixels in the input image and a word in a prompt.

The post-processing can include calculating a coverage score for the word (step S540). The coverage score can be based on the number of pixels in the refined cross-attention map that satisfy a criterion (e.g., a threshold sometimes referred to as a brightness threshold). In some implementations, a ratio of the number of pixels that satisfy the threshold to the total number of pixels can be used as the coverage score. In some implementations, words from the prompt that are part of a predefined set of words are excluded from coverage score calculation (e.g., stop words and preposition words, etc.). In some implementations, the coverage scores for the words can be used to predict classes for the classification task (step S545). In some implementations, a coverage score can be determined for the prompt by combining the coverage scores for the words in the prompt on which post-processing was performed. For example, the total number of pixels that satisfy the criteria (or brightness threshold) across all refined cross-attention maps can be calculated and compared to the total number of pixels. In some implementations, the prompt coverage score can be output and used as a prediction (e.g., probability) for the class that corresponds to the prompt (step S545). Steps S515 and S545 are performed for each separate class for a provided input image. Classification is based on the highest coverage score(s). Moreover, steps S505, S515, and S545 can be performed for multiple input images based on the same class/classes.

Because disclosed methods and systems do not require training or language dependency, implementations can be used for any computer vision problem, including for social media sites, image repositories, robots or AR/VR applications, where the computing device needs understanding of image content. In some implementations, classification can be used with image segmentation, which helps the computing device understand where in an image different objects are located. Segmentation can be used to identify foreground/background regions and the post-processing of the cross-attention maps could concentrate on the pixels corresponding to foreground regions. For example, a segmentation mask can be provided to the classifier (or generated using self-attention maps generated by the stable diffusion model), which provides an indication of which portion(s) of the image correspond to a segmentation layer of interest (e.g., foreground) in the segmentation mask.

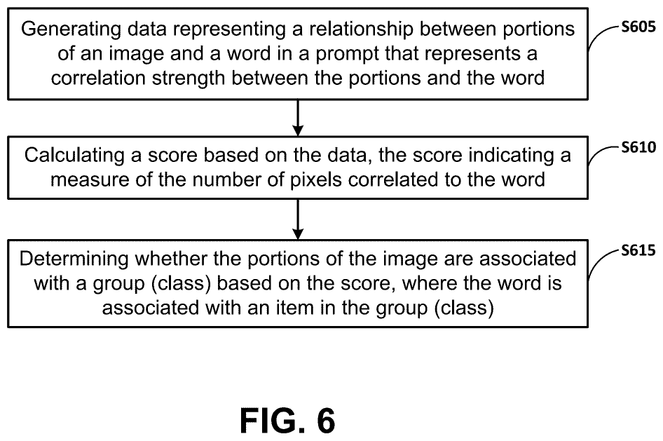

Example 1. FIG. 6 is a block diagram of a method of classification according to an example implementation. As shown in FIG. 6, in step S605 generating a relationship between a portion of an image and terms in a prompt that represents a correlation strength between the portion and a word in the prompt. In step S610 calculating a score based on the data, the score indicating a measure of the number of pixels correlated to the word (or the score indicating a coverage for the word based on the relationship). In step S615 determining whether the portions of the image are associated with a group based on the score, where the word is associated with an item in the group.

Example 2. The method of Example 1 can further include determining a measure of variation (e.g., standard deviation) associated with the data and as part of calculating the score (or prior to calculating the score), multiplying the data by the measure of variation (e.g., standard deviation).

Example 3. The method of Example 1 can further include receiving a plurality of data points representing the relationship between a portion of the portions of the image and the word, the plurality of data points being for different resolutions of the portion, wherein the generating of the data includes aggregating the plurality of data points.

Example 4. The method of Example 1 can further include receiving a plurality of data points representing the relationship between a portion of the portions of the image and the word, the plurality of data points being for different resolutions of the portion and aggregating the plurality of data points as aggregated data, wherein the generating of the data includes refining the aggregated data.

Example 5. The method of Example 4, wherein refining the aggregated data can include multiplying the aggregated data by a measure of variation of the aggregated data.

Example 6. The method of Example 5, wherein the data can correspond to pixels of a portion of the portions of the image and refining the aggregated data can further include subtracting one of a pixel mean or a pixel average for the aggregated data from the aggregated data and multiplying the aggregated data by the measure of variation.

Example 7. The method of Example 1, wherein the prompt can include a plurality of words, the method can further include receiving a plurality of data points representing relationships between the portions of the image and the plurality of words and generating respective refined data for the plurality of words, wherein the score is calculated based on the respective refined data.

Example 8. The method of Example 7, wherein the plurality of words can exclude words in a predefined set of words.

Example 9. The method of Example 1, wherein the data can correspond to pixels of the portions of the image, the method can further include comparing a quantity of pixels in the data with a criterion, and in response to the quantity of pixels satisfying (or meeting) the criterion, calculating the score. In some implementations, the criterion is associated with a total number of pixels in the data.

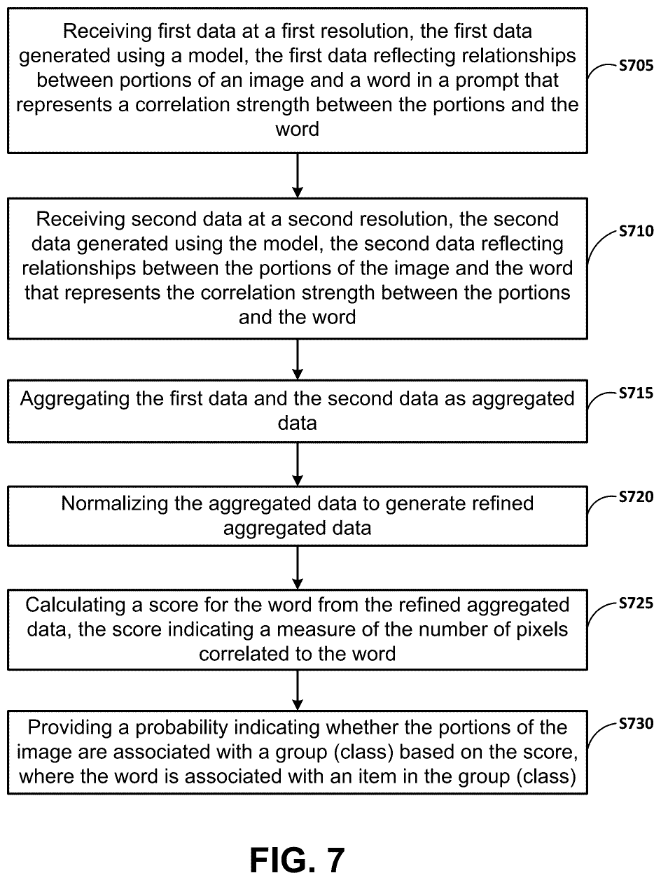

Example 10. FIG. 7 is a block diagram of a method of classification according to an example implementation. As shown in FIG. 7, in step S705 receiving first data at a first resolution, the first data generated using a model, the first data reflecting relationships between portions of an image and a word in a prompt that represents a correlation strength between the portions and the word. In step S710 receiving second data at a second resolution, the second data generated using the model, the second data reflecting relationships between the portions of the image and the word that represents the correlation strength between the portions and the word. In step S715 aggregating the first data and the second data as aggregated data. In step S720 normalizing the aggregated data to generate refined aggregated data. In step S725 calculating a score for the word from the refined aggregated data, the score indicating a measure of the number of pixels correlated to the word (or the score indicating a coverage for the word based on the aggregated data). In step S730 providing a probability indicating whether the portions of the image are associated with a group based on the score, where the word is associated with an item in the group.

Example 11. The method of Example 10 can further include determining a measure of variation associated with the aggregated data, wherein the normalizing of the aggregated data includes multiplying the aggregated data by the measure of variation.

Example 12. The method of Example 11, wherein the first data and the second data can correspond to pixels of a portion of the portions of the image and the normalizing of the aggregated data further includes subtracting one of a pixel mean or a pixel average for the aggregated data from the aggregated data and multiplying the aggregated data by the measure of variation.

Example 13. The method of Example 10, wherein the word can be one of a plurality of words and the plurality of words can excludes words in a predefined set of words.

Example 14. The method of Example 10, wherein the refined aggregated data can correspond to pixels of the portions of the image, the method can further include comparing a quantity of pixels in the refined aggregated data with a criterion and in response to the quantity of pixels satisfying (or meeting) the criterion, calculating the score. In some implementations, the criterion is associated with a total number of pixels in the data.

Example 15. The method of Example 1 or 10, wherein the image can be captured by a camera of a wearable device and the word can be received via an interface of the wearable device.

Example 16. A method can include any combination of one or more of Example 1 to Example 15.

Example 17. A non-transitory computer-readable storage medium comprising instructions stored thereon that, when executed by at least one processor, are configured to cause a computing system to perform the method of any of Examples 1-16.

Example 18. An apparatus comprising means for performing the method of any of Examples 1-16.

Example 19. An apparatus comprising at least one processor and at least one memory including computer program code, the at least one memory and the computer program code configured to, with the at least one processor, cause the apparatus at least to perform the method of any of Examples 1-16.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
generating data representing a relationship between portions of an image and a word in a prompt that represents a correlation strength between the portions and the word;
calculating a score based on the data, the score indicating a measure of a number of pixels correlated to the word; and
determining whether the portions of the image are associated with a group based on the score, where the word is associated with an item in the group.

2. The method of claim 1, further comprising:
determining a measure of variation associated with the data; and
as part of calculating the score, multiplying the data by the measure of variation.

3. The method of claim 1, further comprising:
receiving a plurality of data points representing the relationship between a portion of the portions of the image and the word, the plurality of data points being for different resolutions of the portion, wherein the generating of the data includes aggregating the plurality of data points.

4. The method of claim 1, further comprising:
receiving a plurality of data points representing the relationship between a portion of the portions of the image and the word, the plurality of data points being for different resolutions of the portion; and
aggregating the plurality of data points as aggregated data, wherein the generating of the data includes refining the aggregated data.

5. The method of claim 4, wherein refining the aggregated data includes multiplying the aggregated data by a measure of variation of the aggregated data.

6. The method of claim 5, wherein
the data corresponds to pixels of the portion of the portions of the image, and
refining the aggregated data further includes:
subtracting one of a pixel mean or a pixel average for the aggregated data from the aggregated data, and
multiplying the aggregated data by the measure of variation.

7. The method of claim 1, wherein the prompt includes a plurality of words, the method further comprising:
receiving a plurality of data points representing relationships between the portions of the image and the plurality of words; and
generating respective refined data for the plurality of words, wherein the score is calculated based on the respective refined data.

8. The method of claim 1, wherein the data corresponds to pixels of the portions of the image, the method further comprising:
comparing a quantity of pixels in the data with a criterion, and
in response to the quantity of pixels satisfying the criterion, calculating the score.

9. The method of claim 1, wherein
the image is captured by a camera of a wearable device, and
the word is received via an interface of the wearable device.

10. A method, comprising:
receiving first data at a first resolution, the first data generated using a model, the first data reflecting relationships between portions of an image and a word in a prompt that represents a correlation strength between the portions and the word;
receiving second data at a second resolution, the second data generated using the model, the second data reflecting relationships between the portions of the image and the word that represents the correlation strength between the portions and the word;
aggregating the first data and the second data as aggregated data;
normalizing the aggregated data to generate refined aggregated data;
calculating a score for the word from the refined aggregated data, the score indicating a measure of a number of pixels correlated to the word; and
providing a probability indicating whether the portions of the image are associated with a group based on the score, where the word is associated with an item in the group.

11. The method of claim 10, further comprising determining a measure of variation associated with the aggregated data, wherein the normalizing of the aggregated data includes multiplying the aggregated data by the measure of variation.

12. The method of claim 11, wherein
the first data and the second data correspond to pixels of a portion of the portions of the image, and
the normalizing of the aggregated data further includes subtracting one of a pixel mean or a pixel average for the aggregated data from the aggregated data and multiplying the aggregated data by the measure of variation.

13. The method of claim 10, wherein
the word is one of a plurality of words, and
the plurality of words excludes words in a predefined set of words.

14. The method of claim 10, wherein the refined aggregated data corresponds to pixels of the portions of the image, the method further comprising:
comparing a quantity of pixels in the refined aggregated data with a criterion; and
in response to the quantity of pixels satisfying the criterion, calculating the score.

15. A non-transitory computer-readable storage medium comprising instructions stored thereon that, when executed by a processor, are configured to cause a computing system to:
generate data representing a relationship between portions of an image and a word in a prompt that represents a correlation strength between the portions and the word;
calculate a score based on the data, the score indicating a measure of a number of pixels correlated to the word; and
determine whether the portions of the image are associated with a group based on the score, where the word is associated with an item in the group.

16. The non-transitory computer-readable storage medium of claim 15, wherein the instructions are further configured to cause the computing system to:
receive a plurality of data points representing the relationship between a portion of the portions of the image and the word, the plurality of data points being for different resolutions of the portion, wherein the generating of the data includes aggregating the plurality of data points.

17. The non-transitory computer-readable storage medium of claim 15, wherein the instructions are further configured to cause the computing system to:
receive a plurality of data points representing the relationship between a portion of the portions of the image and the word, the plurality of data points being for different resolutions of the portion; and
aggregate the plurality of data points as aggregated data, wherein the generating of the data includes refining the aggregated data.

18. The non-transitory computer-readable storage medium of claim 17, wherein refining the aggregated data includes multiplying the aggregated data by a measure of variation of the aggregated data.

19. The non-transitory computer-readable storage medium of claim 18, wherein
the data corresponds to pixels of a portion of the portions of the image, and
refining the aggregated data further includes subtracting one of a pixel mean or a pixel average for the aggregated data from the aggregated data and multiplying the aggregated data by the measure of variation.

20. The non-transitory computer-readable storage medium of claim 15, wherein the data corresponds to pixels of the portions of the image, the instructions are further configured to cause the computing system to:
compare a quantity of pixels in the data with a criterion, and
in response to the quantity of pixels satisfying the criterion, calculating the score.
